(19) United States
(12) Patent Application Publication
(10) Pub. No.: US 2010/0218852 A1
(43) Pub. Date: Sep. 2, 2010

(54) Log-feeding device for a bark-stripping machine

(76) Inventor: Jean-Guy Bouchard, Macamic (CA)

Correspondence Address: Franz BONSANG;c/o EQUINOX PROTECTION, 410 - 1500, Du College, St-Laurent, QC, H4L 5G6, CA

(21) Appl. No.: 12/659,096

(22) Filed: Feb. 25, 2010

Related U.S. Application Data
(60) Provisional application No. 61/202,436, filed on Feb. 27, 2009.

(51) Int. Cl. B27B 25/04; B27B 31/00

(52) U.S. Cl. 144/247; 144/248.5

(57) ABSTRACT

A log-feeding device comprises two relatively movable units each carrying automatically self-centering chain-engaging sprockets, the chains being formed of flights provided with channels having serrations and knife-edges for grasping the bark surface of a log being fed therethrough.

### CROSS REFERENCE TO RELATED APPLICATIONS

Benefit of U.S. Provisional Application for Patent Ser. No. 61/202,436 filed on Feb. 27, 2009, which is incorporated herein by reference, is hereby claimed.

### FIELD OF THE INVENTION

The present invention relates to a log-feeding device for a bark-stripping machine.

### BACKGROUND OF THE INVENTION

Many types of such devices have been proposed and operate with varying degrees of efficiency and efficacy. Most of these devices employ at least one array of rollers, which capture and centre logs for their passage to and through the debarking machine. Some examples of the prior art devices are listed as follows: Canadian Patent No. 601,739 to Nicholson; U.S. Pat. No. 3,374,839 to Foster et al; U.S. Pat. No. 3,724,518 to Zehavi et al; U.S. Pat. No. 3,833,162 to Sato; U.S. Pat. No. 4,609,019 to Hutson; and U.S. Pat. No. 6,216,756 to Mason. All of the foregoing propose the use of rollers arranged in differing configurations and mounted on support arms allowing the accommodation of surface contours and a range of log diameters. However, maintenance of devices of this kind can be difficult and required at frequent intervals thus occasioning high operational costs, bearing in mind the loss of production time expended on this activity.

Accordingly, there is a need for an improved log-feeding device, and components thereof, which is relatively simple in design and operation and offers a lower maintenance cost burden by reducing downtime.

### SUMMARY OF THE INVENTION

It is therefore a general object of the present invention to provide an improved log-feeding device, and components thereof, for a bark-stripping machine.

An object of the present invention is to provide a compact log-feeding device with ease of access to its moving parts, thus facilitating maintenance and thereby reducing down time.

Another specific object of the present invention is to provide a powered floating roller assembly for engagement in use with a log to feed same through the device and thence to a debarking machine, the assembly being of relatively simple construction with a self-compensating centering mechanism for ensuring a smooth passage of the log into and through the device and then into the log debarking machine.

A yet further object of the present invention is to provide a feed chain incorporating a plurality of contact members for frictionally engaging and capturing a log for centering and feeding it towards and into the debarking machine, the contact members having a novel and unique operational profile that is functionally effective, and which can accommodate a wide diameter variety of logs, starting with relatively small diameter logs.

According to an aspect of the present invention, there is provided a log feeding 20, device comprising a base mountable on a substructure, two complementary log feeding units connected to one another and mounted on the base, a first log feeding unit including a housing provided with a first drive plate having a first sprocket array comprising a first pair of drive sprockets disposed one above the other and being mounted on first substantially horizontal drive shafts extending through the first drive plate, the axes of the said drive shafts being biased toward one another and movable in relation to the drive plate in an arcuate manner in a substantially vertical plane, a pair of upper and lower idler sprockets disposed one above the other and provided on the housing of the first log feeding unit spaced from the first pair of drive sprockets, first biasing mechanisms associated with said drive shafts for effecting such biasing movement, a second log feeding unit including a housing provided with a second drive plate having a second sprocket array comprising an upper sprocket and a lower sprocket each mounted on a second substantially horizontal drive shaft extending through the second drive plate, the second shafts being movable in relation to the second drive plate in substantially vertical and horizontal planes, actuating and biasing mechanisms associated with said second drive shafts for effecting such relative movement and in use biasing the sprockets of the second log feeding unit toward one another, an upper feeder chain reeved around the upper sprockets of the first feeding and the second feeding units, a lower feeder chain reeved around the lower sprockets of the first feeding unit and the second feeding unit, the upper and lower feeder chains being provided with log-engaging flights together forming a pathway through which in use a log is transported therealong by means of the feeder chain engagement therewith, and a drive arrangement for the sprockets.

In use the base of the log feeding device would be placed upon the substructure, for example the ground or a floor of a wood mill or wherever as appropriate.

The housing of the first log-feeding unit includes a top part on which the drive arrangement for the sprockets is conveniently provided, the drive arrangement consisting of an electric or other motor coupled to a gearbox the axle of which carries a drive pulley over which a drive belt passes and engages pulleys provided on the drive shafts on one side of the first drive plate. The drive belt serves to drive all the sprockets on the first log-feeding unit, the sprockets being disposed on the other side of the first drive plate.

The first log-feeding housing further comprises the first drive plate attached to and depending from the top part, and two sides. The first drive plate is formed with two arcuate slots through which the first drive shafts extend orthogonal thereto.

The housing of the second log-feeding unit includes a top part with the second drive plate attached thereto and depending vertically therefrom with the second drive shafts extending therethrough and carrying the second sprocket array on the side of the plate facing the first log-feeding unit. The second drive plate is also formed with clearance slots through which the drive shafts extend and within which they are capable of moving.

The base is slidably mounted on the substructure for displacement of the device thereon using an actuation mechanism for effecting such displacement. The actuation mechanism is typically constituted by at least one fluid actuable ram acting between the base and the substructure.

Accordingly once the sprockets of the two housings are aligned together a path for a log is thus defined. In this respect upper and lower feed chains are provided in endless loops and are reeved around three upper and three lower sprockets of the two housing. Tensioning of the chain to the appropriate level is achieved by activating the second actuating mechanisms acting on the second drive shafts in a horizontal direction.

Each chain comprises a series of links engageable with the sprockets, the links carrying the log-engaging flights each of channel form with serrations in combination with knife-edges. The channels on each chain at the nip between the two chains form the pathway for the log. It will be understood that the flights on one chain are offset from those on the adjacent chain to avoid interference one with the other during travel.

Suitably placed proximity sensors may be disposed in association with the log-feeding device whereby an approaching log carried on a feed conveyor to the device is sensed and the primary sprockets carried on the second log-feeding unit are actuated to provide an appropriately sized opening to allow feeding of the log into the pathway formed by the two chains. Thereafter the sprockets are biased towards the pathway formed for the passage of the log. In similar manner, the biasing mechanisms provided for the drive sprockets and the idler sprockets of the first log-feeding unit are biased toward such pathway. The biasing mechanisms may conveniently be an open compression spring or may be sealed gas-filled units allowing compression and expansion.

According to another aspect of the present invention, there is provided a log-engaging member device for mounting on a feeder chain for contacting and carrying logs, the log-engaging member device comprises a body formed of a channel section having serrations and knife-edges, the knife-edges being V-shaped and the channel section tapering towards a centre of the member body. The serrations and the knife-edges are substantially perpendicularly oriented relative to one another.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a perspective view of the device taken from the discharge end thereof, and without the feed chains for clarity purposes;

FIG. 2 is a top plan view of the device shown in FIG. 1;

FIG. 3 is an elevation view in the direction of the arrow A in FIG. 1;

FIG. 3a is a front elevation view in the direction of the arrow C in FIG. 1;

FIG. 4 is an elevation view in the direction of the arrow B in FIG. 1;

FIG. 5 is an internal elevation view of the first log-feeding housing showing the biasing mechanisms and the interlocking mechanisms for the sprocket drive shafts;

FIG. 6 is an internal elevation view of the second log-feeding housing showing the biasing and actuating mechanisms and the interlocking mechanisms for the sprocket drive shafts;

FIG. 7 is a side view of the upper and lower feed chains;

FIG. 8 is a view on the line 8-8 of FIG. 7 with a log of relatively large diameter held between the feed chains;

FIG. 9 is a similar view to that shown in FIG. 8 with a log of relatively small diameter held between the feed chains;

FIG. 10 is a perspective view of a flight forming part of the feed chains;

FIG. 10a is an underside perspective view of the flight of FIG. 10;

FIG. 10b is an end elevation view of the flight of FIG. 10a showing the positioning of a log as it is primarily engaged by the flight; and

FIG. 11 is a diagrammatic side view of the log-feeding device in use with logs being primarily captured by and fed through the device between the upper and lower feed chains.

### DETAILED DESCRIPTION OF THE PREFERRED EMBODIMENTS

With reference to the annexed drawings the preferred embodiment of the present invention will be herein described for indicative purpose and by no means as of limitation.

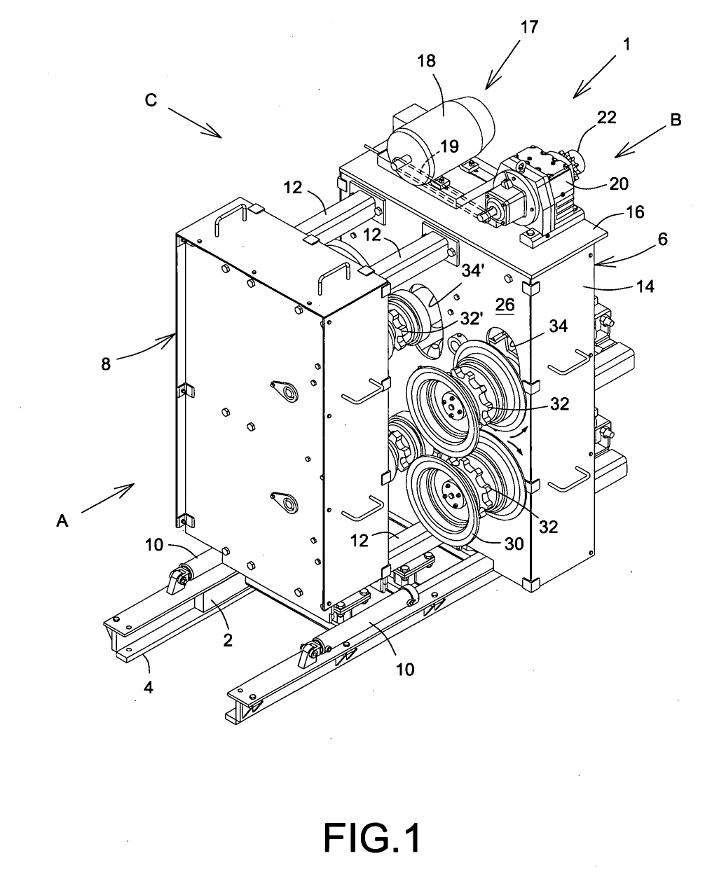

Referring first to FIGS. 1 to 6, there is illustrated a log-feeding device 1 for a debarking machine (not shown) comprising a base 2 slidably mounted on a rigid structure formed of spaced apart ground-engaging guide runners 4, and on which is mounted a first log-feeding unit 6 interconnected with a second log-feeding unit 8 via top and bottom square-sectioned beams 12, relative movement between the units 6, 8 and the base 2 being achieved by a fluid operable ram 10 for each of the runners 4, with each ram 10 being connected to the respective runner 4 and the first log-feeding unit 6 of the device 1. The displacement of the device 1 on the runners 4 provides an easy access to surrounding equipment (not shown) of the debarking machine for maintenance purposes.

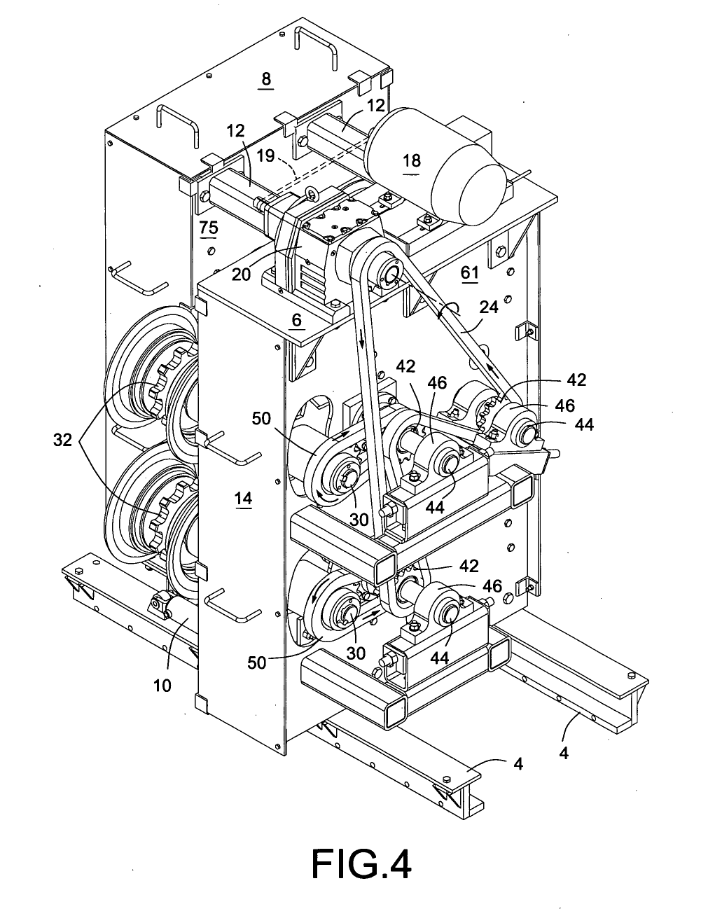

The unit 6 is comprised of a housing 14 having a top plate 16 on which is mounted a drive arrangement 17 consisting of a drive motor 18 driving, via drive belt 19 or the like-(shown in dotted lines in the Figures), a gearbox 20 provided with an output shaft 22 for driving a transmission belt 24. A vertical drive plate 26 provides a base on which movable cantilever arms 28 for upper and lower drive shafts 30 carrying drive sprockets 32 are mounted. The shafts 30 protrude through the drive plate 26 which has arcuate slots 34 provided therein whereby movement of the cantilever arms 28 about respective pivot shaft 27 occasions arcuate movement of the shafts 30 and thus of the sprockets 32. As can be more readily seen in FIG. 4 to the rear of the plate 26 there is arranged a drive set 40 for the transmission belt 24 including three drive cogs 42 mounted on stub shafts 44 in pillow block bearings 46. Secondary belts 50 are provided for driving the drive shafts 30 as seen in the left hand side of FIG. 4. As will be seen the drive belts 24 and 50 are pocketed and engage the teeth of the drive cogs 42 to give positive drive engagement. Idler sprockets 32′ are provided in an upper and a lower disposition relative to one another and in line generally with the upper and lower drive sprockets 32 respectively, to rotate about respective pivot shafts 27′ via cantilever arms 28′, with the shafts 30′ protruding through arcuate slots 34′ of the drive plate 26.

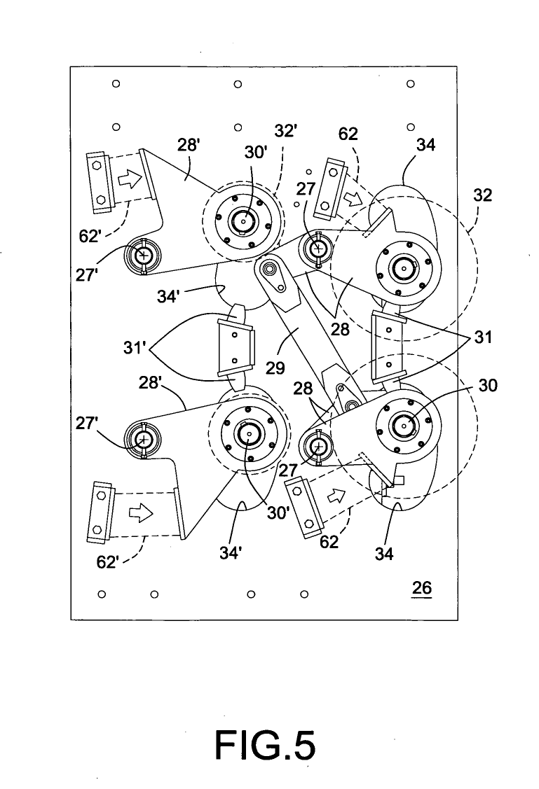

Referring now to FIG. 5 an internal view of the unit 6 is shown and accommodated between the drive plate 26 and another front plate 61 of the unit are biasing mechanisms 62, 62′ such as open compression springs or sealed gas-filled units for biasing swinging movement of the cantilever arms 28, 28′ to bias the respective sprockets 32, 32′ towards one another, and the respective cantilever arms 28, 28′ toward corresponding stopper 31, 31′ preferably made out of flexible material such as rubber or the like. The cantilever arms 28, 28′ are mechanically interlinked for simultaneous opposite displacements via crossbar 29 pivotally connected thereto, whereby clockwise displacement of one arm 28 causes counter-clockwise displacement of the other arm 28, thereby ensuring centering of the log being fed there between.

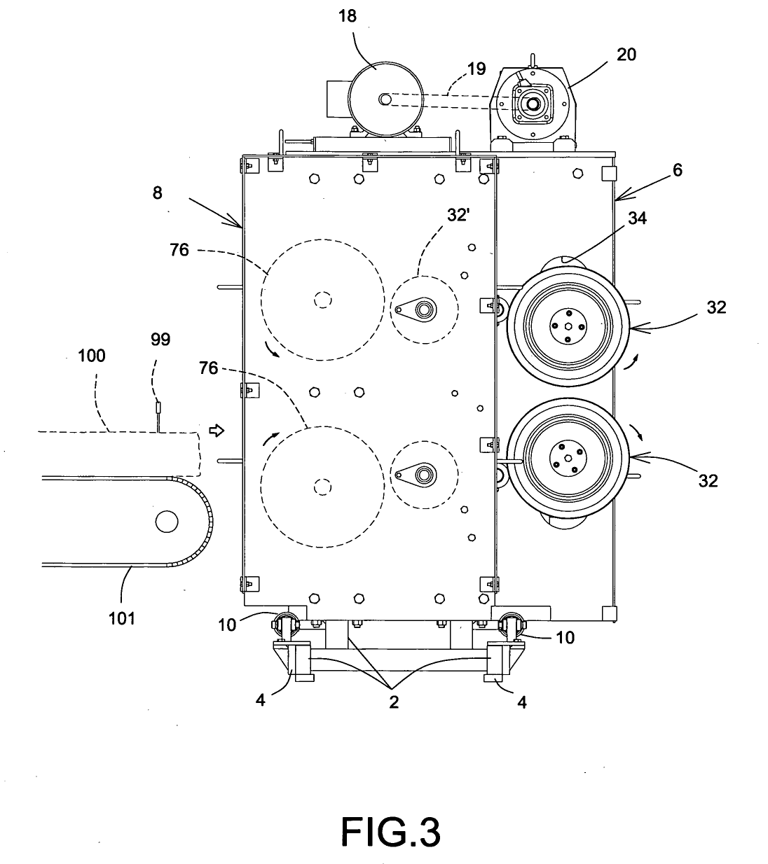

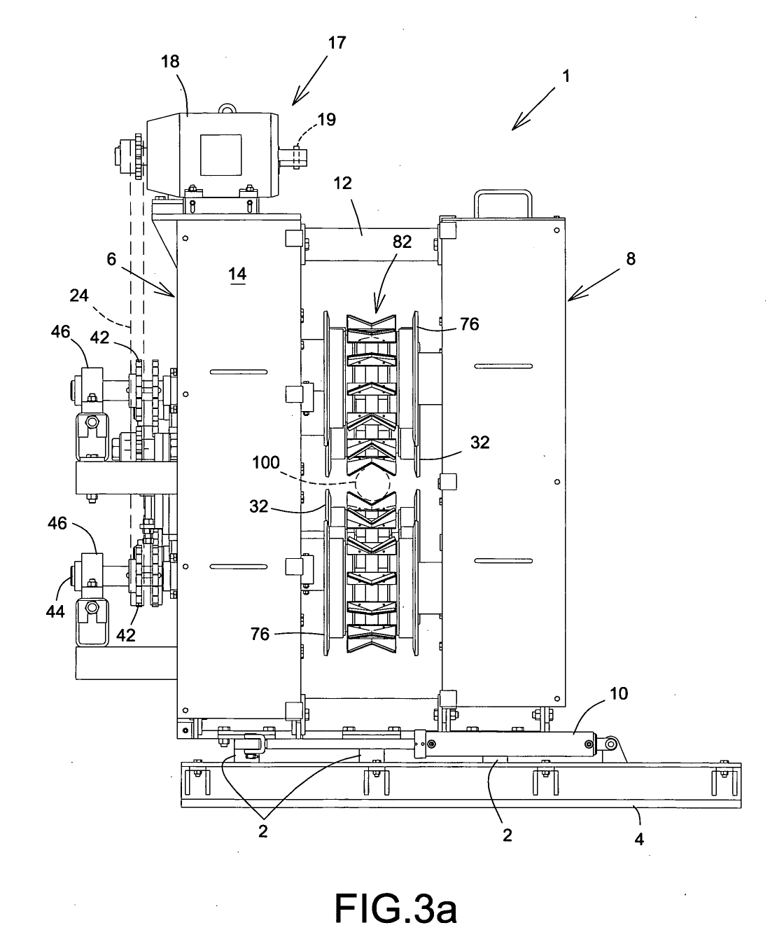

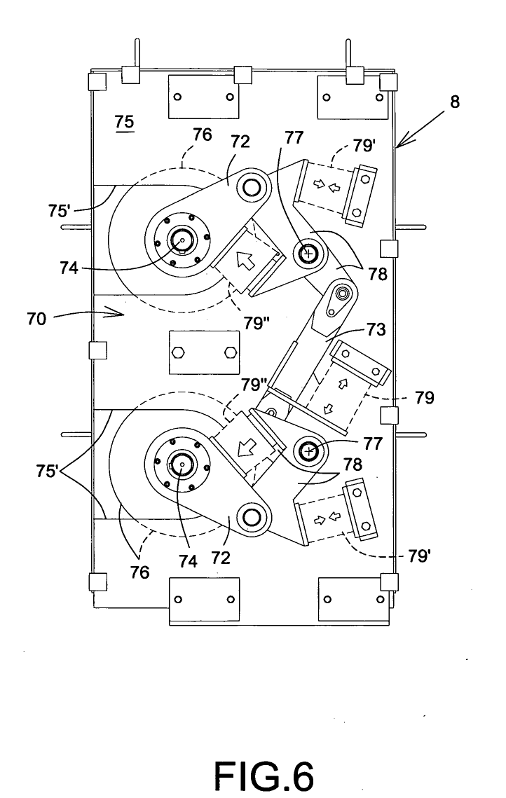

Referring now to FIG. 6, the unit 8 is constituted in part by a housing 70 having a front plate 75 encasing lever arms 72 carrying at their distal ends the drive shafts 74 for sprockets 76. The drive shafts 74 extend through a second drive plate 75 which is provided with suitable clearance slots 75′ allowing vertical and horizontal movement of the shafts. The lever arms 72 are pivotally connected to respective cranks 78 which are interconnected by crossbar 73 pivotally connected thereto. The crossbar 73 (for simultaneous opposite displacement) and the cranks 78, pivotally mounted on the housing 70 about pivot shafts 77, are respectively provided with actuating mechanisms 79, 79′ which latter are fluidly intercommunicating such that added pressure on one 79 occasions a reduction of pressure on the other 79′, thus yielding a balancing and centering effect during use. However, the sprockets 76 represent the entry sprockets which are adapted for opening initially to allow entry into the feeder by a log and are then brought together in support mode. In response to a signal from sensor 99 (see FIG. 3) detecting a specific log diameter reaching the device (controller not shown), the actuating mechanisms 79, typically a sealed gas-filled unit or the like, is inflated, while the other two actuating mechanisms 79′, also typically a sealed gas-filled units or the like, are simultaneously retracted to supply gas into the unit 79 to move the two sprockets 76 away from each other and enable the coming log 100 to get into the device 1 there between. Biasing mechanisms 79″ are provided also for keeping a tension in the feed chain and further aid in resetting the sprockets 76 once the opening mode has been completed.

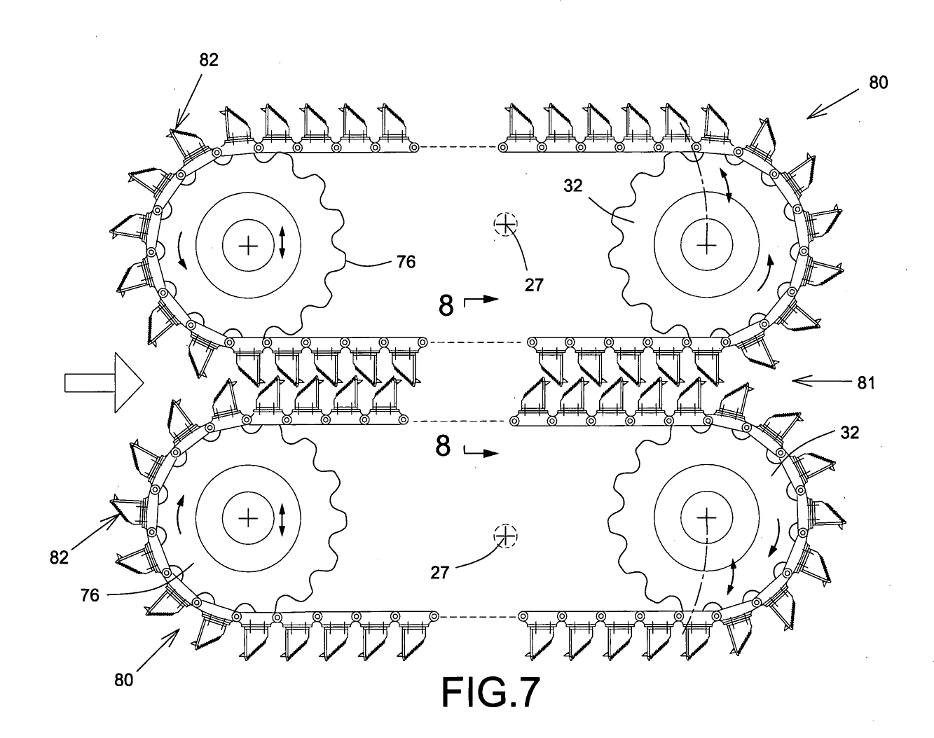

As can be seen from FIG. 7 upper and lower feeder chains 80 are reeved over the sprockets 32 and 76; the mid-sprockets 32′ (as best seen in FIGS. 3 and 5) are idler sprockets used to keep tension into the respective feed chain 80 whilst the sprockets 76 are driven by the end driving sprockets 32 powered by the motor 18. A nip 81 is formed by the chains 80 between the log-engaging member or flights 82 thereof as can more clearly be seen from FIGS. 3a, 8 and 9.

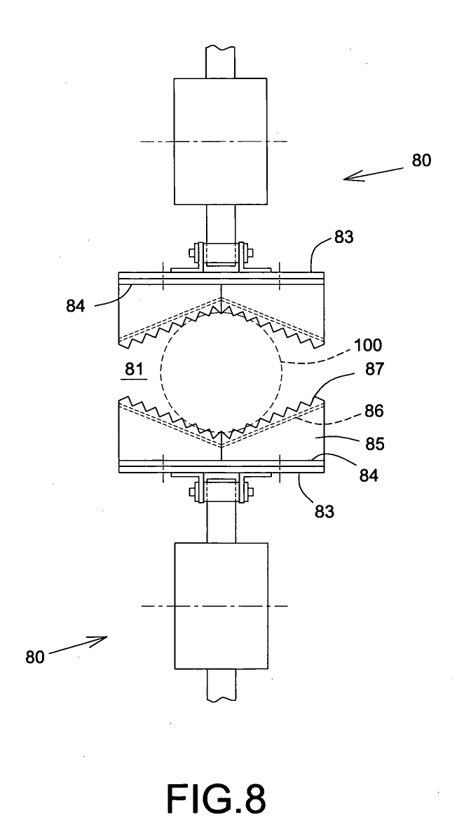

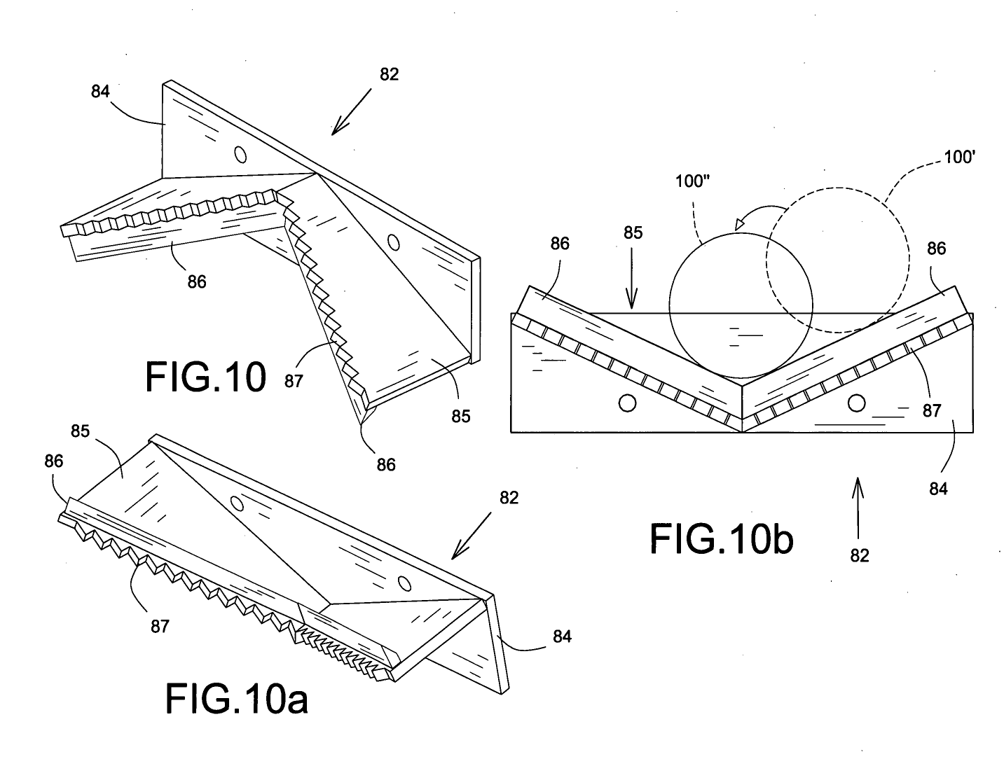

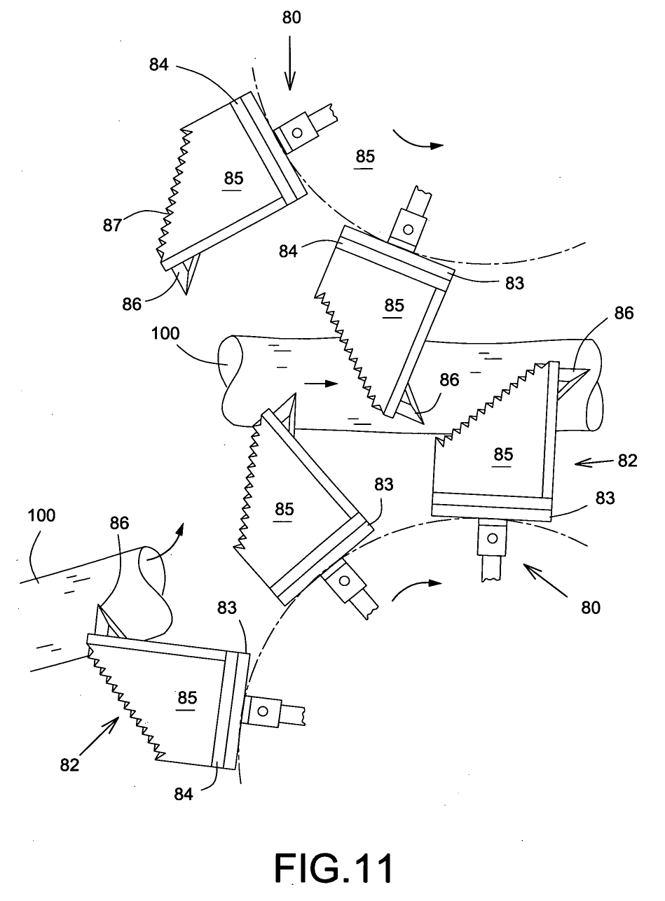

Referring now to FIGS. 10, 10a, and 10b, detailed views of the flights 82 are to be seen. In particular, each flight 82 is bolted to a base plate 83 (see FIGS. 8, 9 and 11) carried by at least one link of the chain 80. The flight 82 comprises a plate 84 to which is welded a shallow V-shaped channel 85 (see FIG. 10b) narrower at its mid point than at its side (see FIGS. 10 and 10a). The channel 85 is bounded at its edge distal from the plate 84 by an upstanding sharpened blade 86 or knife-edge forming the inside of the V-shape and used to ensure gripping of the flight 82 into the log 100 to lift and prevent the latter from sliding back off the flight 82 as shown in the bottom section of FIG. 11. Along the distal edge of the channel 85 there are formed sharp serrations 87 for indenting in use a log to feed same along the device 1 by virtue of the movement of the chains 80.

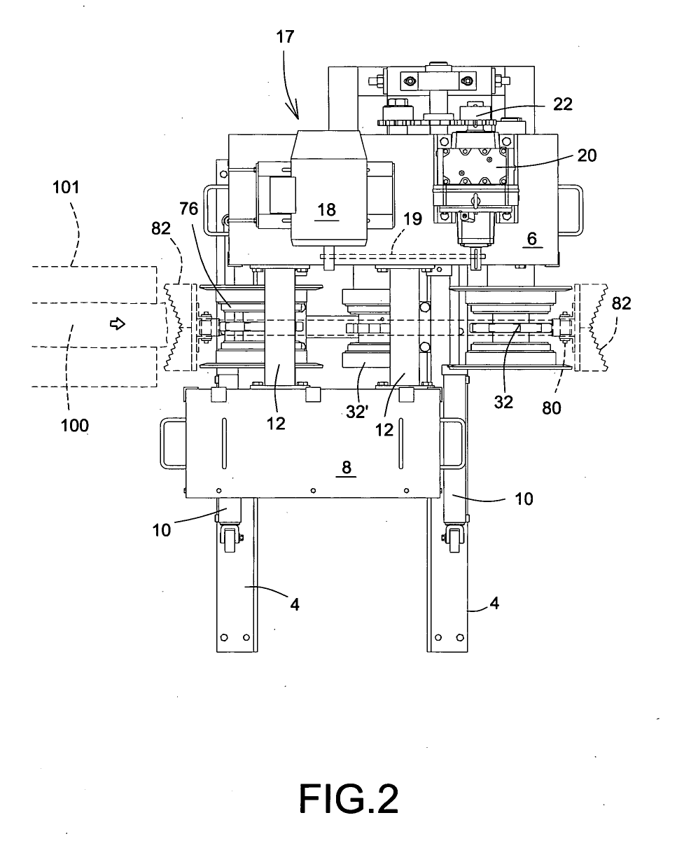

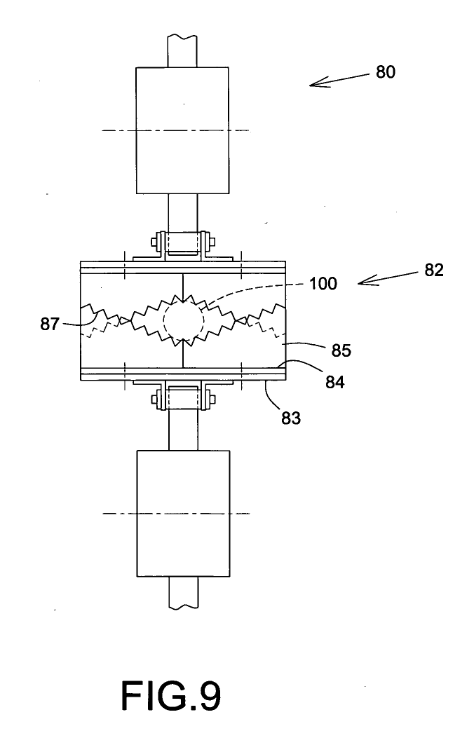

Reference will now be made to FIG. 11, which shows diagrammatically the path of a log into the log-feeding device of the present invention, the motor of the feeder having been started, and the chains 80 now moving in the direction of travel shown in the figure, namely to the right as viewed in the drawing. As a log 100 reaches the entry to the feeder by virtue of it being transported by a conveyor shown in outline at 101 in FIG. 2, it is captured by a flight 82 on the lower chain 80 and more particularly is first snagged by the blade 86 which cuts into the surface of the log. As other flights come into contact with the log they also grab and capture the log and transport it along the pathway defined between the two chains and their flights. The serrations 87 of the flights 82 assist by their frictional engagement with the surface, i.e. the bark, of the log to feed the log to a debarking machine (not shown). FIGS. 8 and 9 show the cross sectional view of logs of greater and lesser diameter respectively captured within the flights 82. FIG. 10b demonstrates the effectiveness of the channel 85 in centering the log should it be initially offset relative to the centre of the pathway. The log 100 merely rolls or slides along the blade 86 into the centre from 100′ to 100″ for a smooth and efficient passage through the feeder.

Furthermore, the profile and construction of the chain flights enables the feeder to cater for wide range of log diameters.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. A log feeding device comprising a base mountable on a substructure, two complementary log feeding units connected to one another and mounted on the base, a first log feeding unit including a housing provided with a first drive plate having a first sprocket array comprising a first pair of drive sprockets disposed one above the other and being mounted on first substantially horizontal drive shafts extending through the first drive plate, the axes of the said drive shafts being biased toward one another and movable in relation to the drive plate in an arcuate manner in a substantially vertical plane, a pair of upper and lower idler sprockets disposed one above the other and provided on the housing of the first log feeding unit spaced from the first pair of drive sprockets, first biasing mechanisms associated with said drive shafts for effecting such biasing movement, a second log feeding unit including a housing provided with a second drive plate having a second sprocket array comprising an upper sprocket and a lower sprocket each mounted on a second substantially horizontal drive shaft extending through the second drive plate, the second shafts being movable in relation to the second drive plate in substantially vertical and horizontal planes, actuating and biasing mechanisms associated with said second drive shafts for effecting such relative movement and in use biasing the sprockets of the second log feeding unit toward one another, an upper feeder chain reeved around the upper sprockets of the first feeding and the second feeding units, a lower feeder chain reeved around the lower sprockets of the first feeding unit and the second feeding unit, the upper and lower feeder chains being provided with log-engaging flights together forming a pathway through which in use a log is transported therealong by means of the feeder chain engagement therewith, and a drive arrangement for the sprockets.

2. A device according to claim 1 wherein the housing of the first log-feeding unit comprises a top part on which the drive arrangement for the sprockets is provided.

3. A device according to claim 2 wherein the drive arrangement consists of an electric motor coupled to a gearbox carrying a drive pulley over which a drive belt passes and engages pulleys provided on the drive shafts on one side of the first drive plate.

4. A device according to claim 3 wherein the drive belt is adapted to drive all the sprockets on the first log-feeding unit, the sprockets being disposed on the other side of the first drive plate.

5. A device according to claim 3 wherein the first log-feeding housing further comprises the first drive plate attached to and depending from the top part, with two sides.

6. A device according to claim 1 wherein the first drive plate is formed with two arcuate slots through which the first drive shafts extend orthogonal thereto and with which in use the said shafts are adapted for movement along the prescribed arcuate paths.

7. A device according to claim 6 wherein the first biasing mechanisms are adapted to move the first drive shafts within the arcuate slots.

8. A device according to claim 1 wherein the housing of the second log-feeding unit comprises a top part with the second drive plate attached thereto and depending vertically therefrom with the second drive shafts extending therethrough and carrying the second sprocket array on the side of the plate facing the first log-feeding unit.

9. A device according to claim 1 wherein the second drive plate is formed with clearance slots through which the drive shafts extend and within which in use they are adapted to move.

10. A device according to claim 1 wherein the base is slidably mounted on the substructure for displacement of the device thereon.

11. A device according to claim 10 wherein an actuation mechanism for effecting such displacement is provided.

12. A device according to claim 11 wherein the actuation mechanism is constituted by at least one fluid actuable ram acting between the base and the substructure.

13. A log feeding device comprising a base mountable on a substructure, two complementary log feeding units connected to one another and mounted on the base, a first log feeding unit including a housing provided with a first drive plate having a first sprocket array comprising a first pair of drive sprockets disposed one above the other and being mounted on first substantially horizontal drive shafts extending through the first drive plate, the axes of the said drive shafts being biased toward one another and movable in relation to the drive plate in an arcuate manner in a substantially vertical plane, a pair of upper and lower idler sprockets disposed one above the other and provided on the housing of the first log feeding unit spaced from the first pair of drive sprockets, first biasing mechanisms associated with said drive shafts for effecting such biasing movement, a second log feeding unit including a housing provided with a second drive plate having a second sprocket array comprising an upper sprocket and a lower sprocket each mounted on a second substantially horizontal drive shaft extending through the second drive plate, the second shafts being movable in relation to the second drive plate in substantially vertical and horizontal planes, actuating and biasing mechanisms associated with said second drive shafts for effecting such relative movement and in use biasing the sprockets of the second log feeding unit toward one another, an upper feeder chain reeved around the upper sprockets of the first feeding and the second feeding units, a lower feeder chain reeved around the lower sprockets of the first feeding unit and the second feeding unit, the upper and lower feeder chains being provided with log-engaging flights together forming a pathway through which in use a log is transported therealong by means of the feeder chain engagement therewith, and a drive arrangement for the sprockets, wherein each upper and lower feed chain comprises a series of links engageable with the sprockets, the links carrying said log-engaging flights.

14. A device according to claim 13 wherein each log-engaging flight is formed of a channel section having serrations and knife-edges substantially perpendicularly oriented relative to one another.

15. A device according to claim 14 wherein the knife-edges are V-shaped and the serrations tapers towards a centre of the channel section.

16. A device according to claim 14 wherein the channels on each chain at the nip between the two chains form the pathway for the log.

17. A device according to claim 16 wherein the flights on one chain are offset with respect to the flights on the other chain.

18. A log-engaging member device for mounting on a feeder chain for contacting and carrying logs, the log-engaging member device comprising a body formed of a channel section having serrations and knife-edges, the knife-edges being V-shaped and the channel section tapering towards a centre of the flight body.

19. A device according to claim 18 wherein the serrations and the knife-edges are substantially perpendicularly oriented relative to one another.
